(19) United States
(12) Patent Application Publication
(10) Pub. No.: US 2020/0139915 A1
(43) Pub. Date: May 7, 2020

(54) STEERING ASSEMBLY FOR VEHICLE STEERING SYSTEM

(71) Applicant: TRW Automotive Safety Systems GmbH, Aschaffenburg (DE)

(72) Inventors: André Funk, Aschaffenburg (DE); Marc Friess, Leidersbach (DE); Markus Haas, Oberzent (DE)

(21) Appl. No.: 16/665,004

(22) Filed: Oct. 28, 2019

(30) Foreign Application Priority Data
Nov. 6, 2018 (DE) 10 2018 127 636.2

(51) Int. Cl. B60R 21/203

(52) U.S. Cl. CPC B60R 21/203

(57) ABSTRACT

The invention relates to a steering assembly (10) for a vehicle steering system, comprising a first coupling component, especially an airbag module (16), including at least one rigid latch hook (12), and a second coupling component, especially a mounting plate (18), including a pre-mounted spring element (14), wherein the two coupling components are movable toward each other along a mounting axis (A) until a portion of the spring element (14) engages behind the at least one latch hook (12) in a securing position and interconnects the coupling components, wherein the spring element (14) is movable between a coupling position in which the spring element (14) is largely relaxed and engages behind the at least one latch hook (12) and a decoupling position in which the spring element (14) is tensioned and is spaced apart from the latch hook (12) transversely to the mounting axis (A), the second coupling component including a retaining element (22) for fixing the spring element (14) in the decoupling position.

### BACKGROUND OF THE INVENTION

The invention relates to a steering assembly for a vehicle steering system, comprising an airbag module and a mounting plate for securing the airbag module on a steering wheel.

Front airbag modules for restraining vehicle occupants are usually disposed, on the driver side, in the hub area of the steering wheel so that, upon activation of the module after a vehicle crash, an airbag deploys in front of and protects the vehicle occupant.

In view of the mounting method, usually at first the steering wheel without the airbag module is secured to the steering column and subsequently the airbag module is connected to, especially latched with, the steering wheel hub. Latching advantageously enables easy, reliable and extremely quick mounting of the airbag module without any tools being required.

In order to ensure sufficiently reliable and robust fastening of the airbag module by latching, considerable axial mounting forces have to be applied with respect to a steering column axis, however. In successive mounting operations on an industrial assembly line this may entail high physical load and rapid fatigue of the assembler in charge.

### SUMMARY OF THE INVENTION

Therefore, it is the object of the invention to provide a steering assembly in which the mounting force required to establish a latching connection between the airbag module and the vehicle steering wheel is especially low.

According to the invention, this object is achieved by a steering assembly for a vehicle steering system, comprising a first coupling component, especially an airbag module that includes at least one latch hook, and a second coupling component, especially a mounting plate that includes a pre-assembled spring element, the coupling components being movable toward each other along a mounting axis until a portion of the spring element engages behind the at least one latch hook in a securing position and interconnects the coupling components, wherein the spring element is movable between a coupling position in which the spring element is largely relaxed and engages behind the at least one latch hook, and a decoupling position in which the spring element is tensioned and is spaced apart from the latch hook transversely to the mounting axis, and wherein the second coupling component includes a retaining element for fixing the spring element in the decoupling position.

In conventional steering assemblies, the latch hook usually includes a latch lug, with an inclined surface for tensioning the spring element being provided at the rear of the latch lug. When feeding the airbag module in the axial mounting direction, the spring element is initially tensioned at the rear of the latch lug before it will snap back into the coupling position and engage behind the latch hook. Tensioning of the spring element when securing the airbag module on the steering wheel results in undesirably high mounting forces. Due to the retaining element provided on the second coupling component, the spring element can be supplied to the assembly line already in a biased condition and can be moved past the latch lug of the latch hook in the axial mounting direction without effort so that advantageously no axial mounting forces have to be applied for tensioning the spring element.

The retaining element for fixing the spring element in the decoupling position preferably is an axial projection arranged on, especially integrally formed with, the second coupling component. In this way, desired fixation of the spring element can be realized especially easily with minimum effort.

The retaining element may particularly be a ramp, with a ramp slope in the coupling position of the spring element facing the spring element and in the decoupling position of the spring element being remote from the spring element. Said ramp helps to slightly bias the spring element, while biasing the same transversely to the mounting axis, simultaneously also in the axial direction. Said axial bias is sufficient to snap in the tensioning direction behind the retaining element axially into the decoupling position in which the spring element is biased transversely to the mounting axis.

In one embodiment of the steering assembly, the first coupling component includes an actuating element spaced apart from the latch hook for releasing the spring element from its decoupling position. After having passed the latch lug of the latch hook during mounting, the spring element is axially loaded by the actuating element until it cannot be retained in its decoupling position any longer by the retaining element and snaps into its coupling position.

Preferably, the actuating element is an axial projection, especially an axially extending pin, which in the decoupling position of the spring element is axially aligned with a portion of the spring element.

The second coupling component preferably includes an axial through-hole through which the actuating element can extend. In this way, the actuating element attached to the first coupling component can easily load the spring element which is arranged on a side of the second coupling component remote from the first coupling component.

In accordance with a preferred embodiment, the first coupling component is an airbag module and the second coupling component is a mounting plate of the steering assembly. As an alternative, it is also imaginable, as a matter of course, that the mounting plate is provided with the latch hook and thus forms the first coupling component, whereas the airbag module includes a pre-mounted spring element and, accordingly, constitutes the second coupling component.

The spring element preferably is arranged on an axial end face of the mounting plate remote from the airbag module.

The actuating element is preferably provided on a module bottom of the airbag module facing the mounting plate, the module bottom being especially in the form of a generator support for a gas generator of the airbag module. Alternatively, also configuration variants in which the actuating element is provided on the sidewall of a module cap of the airbag module are imaginable.

According to another embodiment, the steering assembly also comprises a steering wheel skeleton, with the mounting plate being axially arranged between the airbag module and the steering wheel skeleton as a separate component. In this embodiment, the mounting plate is secured on the steering wheel skeleton in a preferably oscillating manner, thus allowing advantageous vibration absorption, i.e. minimization of undesired steering wheel vibrations, to be realized in the vehicle steering system.

In alternative configuration variants, the mounting plate may also be integrated in one piece in the steering wheel skeleton.

### BRIEF DESCRIPTION OF THE DRAWINGS

Further features and advantages of the invention will be evident from the following description of a preferred embodiment with reference to the drawings, wherein:

FIG. 1 shows a perspective view of a steering assembly according to the invention comprising an airbag module and a mounting plate;

FIG. 2 shows an axial top view onto the mounting plate of the steering assembly according to FIG. 1;

FIG. 3 shows a perspective detail view of the steering assembly according to FIG. 1 when the airbag module is mounted on the mounting plate;

FIG. 4 shows a perspective detail view according to FIG. 3 just before latching between the airbag module and the mounting plate;

FIG. 5 shows a perspective detail view according to FIG. 3 after latching between the airbag module and the mounting plate;

FIG. 6 shows a perspective view of an airbag module in its pre-mounted position prior to latching with a mounting plate;

FIG. 7 shows a perspective view of the airbag module according to FIG. 6 in its pre-mounted position after latching with the mounting plate;

FIG. 8 shows a perspective view of the airbag module according to FIG. 6 in its final mounting position after latching with the mounting plate; and

FIG. 9 shows a perspective exploded view of a steering assembly according to the invention.

### DESCRIPTION

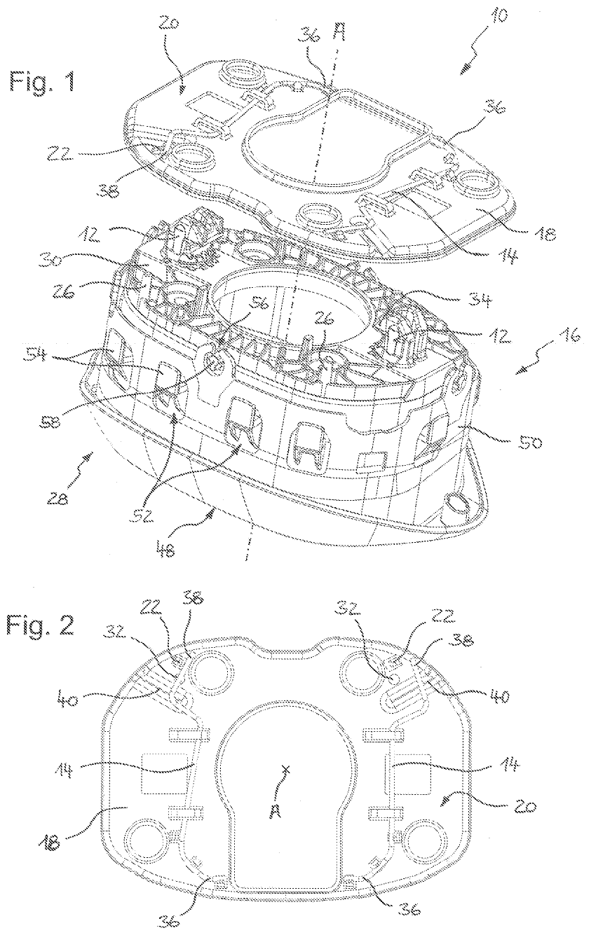

FIGS. 1 to 9 illustrate a steering assembly 10 for a vehicle steering system comprising a first coupling component including a rigid latch hook 12 and a second coupling component including a pre-mounted spring element 14, wherein the two coupling components are movable toward each other along a mounting axis A until a portion of the spring element 14 engages behind the at least one latch hook 12 in a securing position and interconnects the coupling components (see FIG. 5).

In the present example embodiment, the first coupling component is an airbag module 16 and the second coupling component is a mounting plate 18.

It is easily evident for those skilled in the art, of course, that alternatively also the mounting plate 18 might include the latch hook 12 and the airbag module 16 might include the pre-mounted spring element 14. In this case, the mounting plate 18 consequently would be the first coupling component and the airbag module 16 would be the second coupling component. The general concept of connection described hereinafter can also easily be conferred upon such configuration variant.

By way of FIGS. 1 and 2 it becomes clear that, in the present example embodiment, two rigid latch hooks 12 as well as two separate spring elements 14 are provided, with one spring element 14 being assigned to each latch hook 12. As an alternative, the two spring elements 14 may also be formed in one piece, for example as a U-shaped spring, wherein in such case one movable spring leg would be assigned to each latch hook 12. In general, also configuration variants in which a different number of latch hooks 12 is provided are imaginable.

The spring elements 14 are arranged, according to FIG. 1, on an axial end face 20 of the mounting plate 18 remote from the airbag module 16.

Each spring element 14 is movable between a coupling position in which the spring element 14 is largely relaxed and can engage behind the at least one latch hook 12 (cf. FIG. 2, right-hand spring element 14) and a decoupling position in which the spring element 14 is tensioned and is spaced apart from the latch hook 12 transversely to the mounting axis A (cf. FIG. 2, left-hand spring element 14).

The mounting plate 18 includes a retaining element 22 for fixing the spring element 14 in the decoupling position, wherein, in the shown embodiment, the retaining element 22 is a projection formed integrally with the mounting plate 18 which projects axially from the end face 20 of the mounting plate 18.

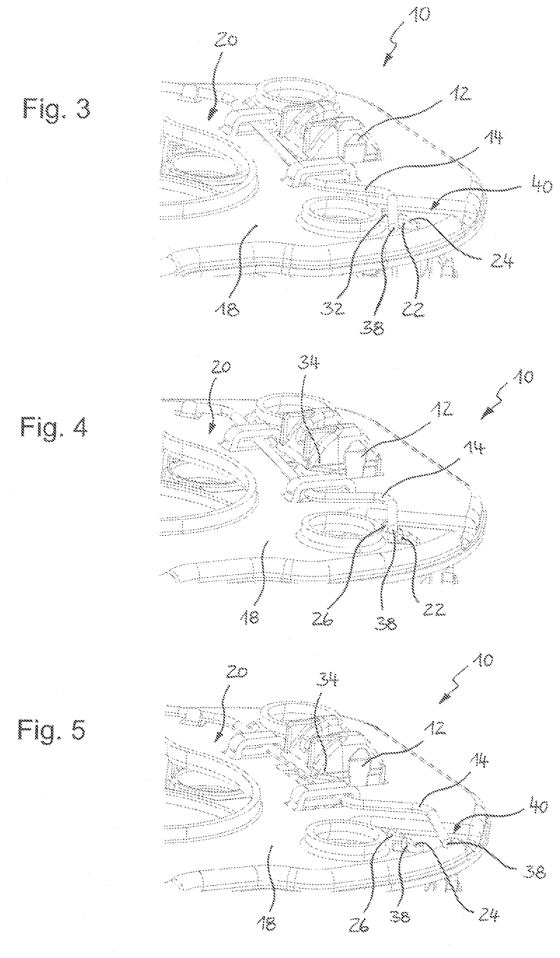

Concretely speaking, said projection is a ramp, wherein a ramp slope 24 in the coupling position of the spring element 14 faces the spring element 14 (FIG. 5) and in the decoupling position of the spring element 14 is remote from the spring element 14 (FIG. 3).

In order to release the spring element 14 from its tensioned decoupling position, the airbag module 16 includes an actuating element 26 spaced apart from the latch hook 12.

According to FIG. 1, the airbag module 16 comprises, inter alia, a module cap 28 which in the mounted state of the airbag module 16 faces an occupant, and a module bottom 30 which includes the latch hooks 12 for securing the airbag module 16 on a vehicle component, especially on a vehicle steering wheel. The actuating element 26 in this case is a pin-shaped projection which extends from a side of the module bottom 30 facing the mounting plate 18 axially in the direction of the mounting plate 18 and in the decoupling position of the spring element 4 is axially aligned with a portion of the spring element 14.

Here, the module bottom 30 is manufactured as an injection-molded part of robust plastic material, with the actuating element 26 being especially integrally formed with the module bottom 30.

According to FIG. 2, the mounting plate 18 includes an axial through-hole 32 which is axially aligned with the actuating element 26, the actuating element 26 extending through said through-hole 32 for releasing the spring element 14 from its tensioned decoupling position.

In the following, the mounting operation of the airbag module 16 on the mounting plate 18 will be briefly explained by way of FIGS. 3 to 5.

At the beginning of the mounting operation, the spring element 14 pre-mounted to the mounting plate 18 is in its tensioned decoupling position in which the spring element 14 is spaced apart from the latch hook 12 transversely to the mounting axis A. According to FIG. 3, when the airbag module 16 is axially fed, the latch hook 12 may consequently move unhindered past the side of the spring element 14 without axially or radially loading the spring element 14.

When, according to FIG. 4, an axial relative position is reached in which a latch lug 34 of the latch hook 12 has passed the spring element 14, the pin-shaped actuating element 26 gets into contact with the spring element 14 and loads the spring element 14 in the axial direction. The spring element 14 thus slides past the retaining element 22 until it snaps radially outwardly into its coupling position.

In the coupling position according to FIG. 5, the spring element 14 engages behind the latch hook 12, concretely speaking the latch lug 34 of the latch hook 12, so that the airbag module and the mounting plate are coupled to each other and are fixed relative to each other in an axial securing position. Compared to the decoupling position, in the coupling position the spring element 14 is relaxed, wherein even in the coupling position certain residual tension may still be provided, however.

Thus, mounting of the airbag module 16 on the mounting plate 18 is completed.

It is clearly visible from FIG. 2 that the spring element 14 includes a tight spring end 36 fixed to the mounting plate 18 and a radially movable free spring end 38. In the area of the free spring end 38, a dismounting groove 40 for dismounting the airbag module 16 is provided on the end face 20 of the mounting plate 18. Said dismounting groove 40 extends substantially in the radial direction and is accessible by a tool from outside the steering wheel even in a condition of the airbag module 16 mounted on the vehicle steering wheel. The tool then is adapted to be radially inserted into the dismounting groove 40 and can return the spring element 14 into its decoupling position according to FIG. 3 so that the airbag module 16 can be easily removed from the mounting plate 18 again in the axial direction.

The steering assembly 10 also comprises, according to FIG. 9, a steering wheel 42 including a steering wheel skeleton 44, with the mounting plate 18 being axially arranged as a separate component between the airbag module 16 and the steering wheel skeleton 44.

In the illustrated example embodiment of the steering assembly 10, the mounting plate 18 is secured to the steering wheel skeleton 44 via vibration dampers 46 so that the mounting plate 18 and the steering wheel skeleton 44 are connected in an oscillating manner.

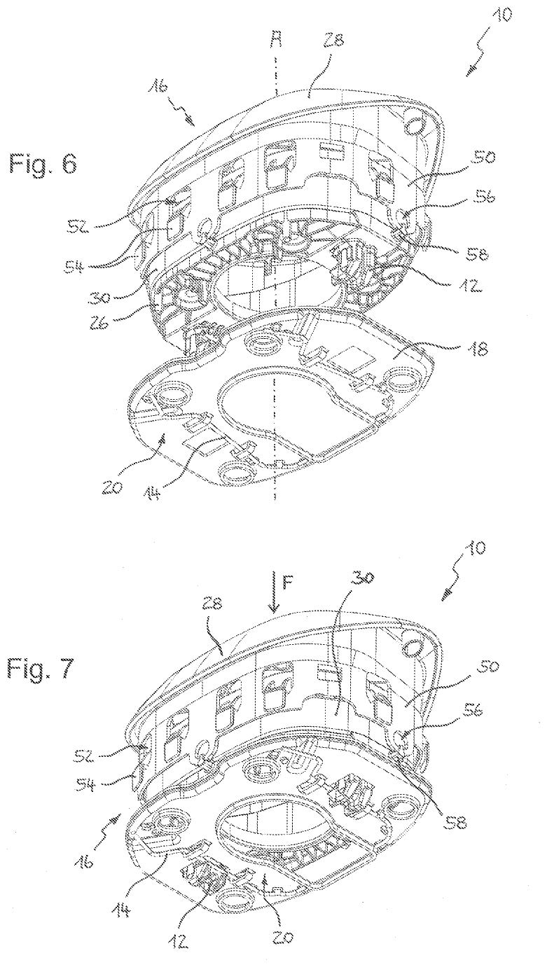

FIGS. 6 to 8 illustrate perspective views of the steering assembly 10 by way of which special features of the airbag module 16 for an occupant restraint system will be explained in the following.

The airbag module 16 comprises, according to FIGS. 6 to 8, the module cap 28 which in the mounted condition of the airbag module 16 faces an occupant and the module bottom 30 which includes a latch means in the form of a latch hook 12 for securing the airbag module 16 to a vehicle component, especially to a mounting plate 18 or a vehicle steering wheel.

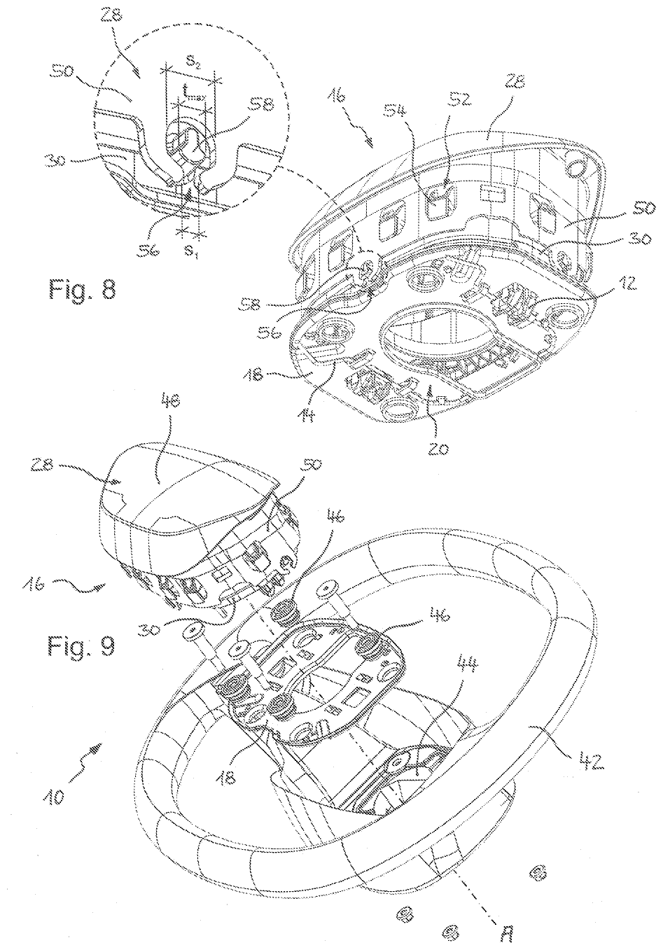

The module cap 28 and the module bottom 30 are movable toward each other along a mounting axis A until they reach at first a pre-mounting position (FIGS. 6 and 7) and then an axial final mounting position (FIG. 8), wherein the module cap 28 and the module bottom 30 include interacting pre-fixing elements which captively secure the module cap 28 and the module bottom 30 to each other in the pre-mounting position.

In the present example embodiment, the module cap 28 is pot-shaped and has an axial end wall 48 and a peripheral wall 50. As pre-fixing elements in the peripheral wall 50 of the module cap 28 plural pre-mounting windows 52 and at the module bottom 30 plural pre-mounting hooks 54 are provided each of which engages in an assigned pre-mounting window 52 and which thus captively connect the module cap 28 and the module bottom 30 in the pre-mounting position of the airbag module 16. In this manner, the airbag module 16 in its pre-mounting position forms a structural unit which can be easily transported and further processed. The pre-fixing elements do not provide for a rigid zero-clearance connection, however, but permit a certain relative movement between the module cap 28 and the module bottom 30 both in the axial direction and in the radial direction.

Apart from the pre-fixing elements, the module cap 28 and the module bottom 30 further include interacting resistance contours which offer predetermined mounting resistance during axial relative movement of the module cap 28 and the module bottom 30 from the pre-mounting position to the final mounting position.

The resistance contours in the shown embodiment are especially latching contours for latching the module cap 28 and the module bottom 30 in the final mounting position.

Concretely speaking, the resistance contours are in the form of an axially extending slit 56 in the peripheral wall 50 of the module cap 28 at an axial end remote from the end wall 48 and in the form of a radial journal 58 at the module bottom 30.

The slit 56 includes, when viewed in the axial direction, at least in portion a tangential slit width s that is smaller than a maximum tangential dimension tₘₐₓ of the radial journal 58. This results in the mounting resistance upon movement from the pre-mounting position to the final mounting position.

Especially, at an end of the peripheral wall 50 remote from the axial end wall 48, the slit 56 has a first slit width Si smaller than the maximum tangential dimension tₘₐₓ of the radial journal 58, wherein the slit width s then is increasing toward the axial end wall 48 until it reaches a second slit width s₂ larger than the maximum tangential dimension tₘₐₓ of the radial journal 58.

By way of the detail cutout concerning FIG. 10, it is evident that the radial journal 58 in the shown final mounting position of the airbag module 16 is spaced apart from the edges of the slit 56 transversely to the radial direction.

Hence, in the final mounting position of the airbag module 16 a relative movement between the module cap 28 and the module bottom 30 is not obstructed by the resistance contours so that the module cap 28 and the module bottom 30 relative to each other have axial and radial play even in the final mounting position.

The radial journal 58 and/or the peripheral wall 50 of the module cap 28 is/are made from resilient, especially elastically resilient material, preferably from suitable plastic material, at least in the area of the slit 56.

Via parameters such as the material of the journal 58 and/or of the peripheral wall 50, a wall thickness of the peripheral wall 50 in the area of the slit 56 as well as the proportion between minimum slit width and maximum tangential dimension of the journal 58, a desired mounting resistance can be easily and precisely adjusted.

The afore-described airbag module 16 for an occupant restraint system forms a steering assembly 10 for a vehicle steering system together with the steering wheel 42 including a steering wheel skeleton 44 and the mounting plate 18 arranged on the steering wheel side for securing the airbag module 16 to the steering wheel skeleton 44. The latch means (latch hook 12) on the module bottom 30 of the airbag module 16 constitutes a first latch means which upon axial movement of the airbag module 16 relative to the mounting plate 18 latches with a second latch means (spring element 14) provided on the mounting plate 18, wherein a mounting resistance for latching of the first and second latch means is lower than a mounting resistance of the resistance contours when transferring the airbag module 16 from the pre-mounting position to the final mounting position. This is illustrated in the mounting state according to FIG. 7, where the airbag module 16 still is in its pre-mounting position, but the latching of the airbag module 16 with the mounting plate 18 has been effectuated. This can be properly realized especially when the airbag module 16 can be latched to the mounting plate 18 with low mounting resistance, viz. for example by latching as described before especially by way of the FIGS. 3 to 5.

In accordance with FIG. 9, the mounting plate 18 is axially arranged between the airbag module 16 and the steering wheel skeleton 44 of the steering wheel 42 as a separate component and is fastened to the steering wheel skeleton 44 in an oscillating manner via vibration dampers 46.

By virtue of the play between the module cap 28 and the module bottom 30 in the final mounting position of the airbag module 16, the module cap thus can be received with minimum gap width extremely true to size and substantially fixed in the steering wheel 42, whereas the remaining airbag module 16 including the mounting plate 18 is movable relative to the steering wheel 42 to a limited extent and thus advantageously can act as vibration absorber and can dampen undesired vibrations in the vehicle steering system.

Optionally, the module cap 28 may further include a fastener (not shown) which in the final mounting position of the airbag module 16 directly connects the module cap 28 to the steering wheel 42.

Hereinafter, finally mounting of the airbag module 16 on the steering wheel 42 for forming the steering assembly 10 shall be dealt with.

At first the airbag module 16 is provided in its pre-mounting position according to FIG. 6.

Moreover, the steering wheel 42 including the steering wheel skeleton 44 and the mounting plate 18 secured to the steering wheel skeleton 44 is provided. As illustrated in FIG. 9, the mounting plate 18 can be secured to the steering wheel skeleton 44 especially via vibration dampers 46 so that the mounting plate 18 and the steering wheel skeleton 44 are connected in an oscillating manner.

Subsequently, the airbag module 16 is fed toward the steering wheel skeleton 44 along the mounting axis A and, according to FIG. 7, an axial mounting force F is applied to the module cap 28 of the airbag module 16, wherein at first the latch means of the airbag module 16 and of the mounting plate 18, i.e. the latch hook 12 and the spring element 14, form a latching connection and only thereafter the airbag module 16 is transferred from its pre-mounting position to its final mounting position according to FIG. 8.

Optionally, the module cap 28 can be fixed, when the airbag module 16 is transferred from the pre-mounting position to the final mounting position, substantially simultaneously directly to the steering wheel 42 and especially latched with the steering wheel 42.

1. A steering assembly for a vehicle steering system, comprising:
a first coupling component, especially an airbag module (16) including at least one latch hook (12), and
a second coupling component, especially a mounting plate (18) including a pre-mounted spring element (14),
wherein the coupling components can be moved toward each other along a mounting axis (A) until a portion of the spring element (14) engages behind the at least one latch hook (12) in a securing position and interconnects the coupling components,
wherein the spring element (14) is movable between a coupling position in which the spring element (14) is largely relaxed and engages behind the at least one latch hook (12) and a decoupling position in which the spring element (14) is tensioned and is spaced apart from the latch hook (12) transversely to the mounting axis (A),
wherein the second coupling component includes a retaining element (22) for fixing the spring element (14) in the decoupling position.

2. The steering assembly according to claim 1, wherein the retaining element (22) is an axial projection attached to, especially integrally formed with, the second coupling component.

3. The steering assembly according to claim 2, wherein the retaining element (22) is in the form of a ramp, wherein a ramp slope (24) in the coupling position of the spring element (14) faces the spring element (14) and in the decoupling position of the spring element (14) is remote from the spring element (14).

4. The steering assembly according to claim 1, wherein the first coupling component includes an actuating element (26) for releasing the spring element (14) from its decoupling position.

5. The steering assembly according to claim 4, wherein the actuating element (26) is an axial projection which in the decoupling position of the spring element (14) is axially aligned with a portion of the spring element (14).

6. The steering assembly according to claim 4, wherein the second coupling component includes an axial through-hole (32) through which the actuating element (26) can extend.

7. The steering assembly according to claim 1, wherein the first coupling component is an airbag module (16) and the second coupling component is a mounting plate (18).

8. The steering assembly according to claim 7, wherein the spring element (14) is arranged on an axial end face (20) of the mounting plate (18) remote from the airbag module (16).

9. The steering assembly according to claim 7, wherein the actuating element (26) is provided on a module bottom (30) of the airbag module (16) facing the mounting plate (18).

10. The steering assembly according to claim 7, wherein a steering wheel skeleton (44) is provided, the mounting plate (18) being axially arranged between the airbag module (16) and the steering wheel skeleton (44) as a separate component.

11. The steering assembly according to claim 10, wherein the mounting plate (18) is secured to the steering wheel skeleton (44) in an oscillating manner.
